(19) United States
(12) Patent Application Publication
(10) Pub. No.: US 2008/0296093 A1
(43) Pub. Date: Dec. 4, 2008

(54) Lubricating Switch

(76) Inventor: John F. Schippers, Orangeville (CA)

Correspondence Address: MILLER THOMPSON, LLP, Scotia Plaza, 40 King Street West, Suite 5800, TORONTO, ON, M5H 3S1, CA

(21) Appl. No.: 11/944,074

(22) Filed: Nov. 21, 2007

Related U.S. Application Data
(60) Provisional application No. 60/860,800, filed on Nov. 24, 2006.

(51) Int. Cl. F16N 7/00; F16H 57/05

(52) U.S. Cl. 184/15.2; 184/27.1; 184/109

(57) ABSTRACT

A moveable member for activating the discharge of lubricant wherein the moveable member is comprised of a breakable material. A method of minimizing damage to a conveyor system due to the displacement of a lubricating activating member by selecting the material of the activating member from a group of materials which is destructible by the conveyor system without affecting the conveyor system.

This application claims priority from U.S. Provisional Application No. 60/860,800, filed on Nov. 24, 2006.

### FIELD OF INVENTION

This invention relates to a lubricating switch and in particular relates to a moveable member for activating the discharge of lubricant. The invention also relates to a method for activating the discharge of lubricant wherein the lubricant member is comprised of breakable material.

### BACKGROUND TO THE INVENTION

Lubricants are generally used to reduce friction and thus prolong the working life of a particular device. Lubricants are commonly used in a variety of environments including conveyor systems as well as overhead track conveyor systems.

For example, U.S. Pat. No. 5,289,899 relates to apparatus and method for lubricating conveyors. Furthermore, U.S. Pat. No. 5,213,180 relates to a lubricant applicator for drive chains, while U.S. Pat. No. 4,679,659 relates to a method and apparatus for lubricating a moving chain

Many of prior art lubricating switches utilize materials that can potentially damage machinery, driving mechanisms such as chains, pulleys and the like particularly when portions of the lubricating switch become accidentally dislodged and fall toward the chain, driving means, or conveyor systems.

It is an object of this invention to provide an improved lubricating switch. It is another object of this invention to provide an improved method minimizing damage even when portions of the lubricating switch accidentally become dislodged.

### DISCLOSURE OF INVENTION

It is an aspect of this invention to provide a moveable member for activating the discharge of lubricant wherein the moveable member is comprised of a breakable material.

It is another aspect of this invention to provide a device for activating the discharge of lubricant to a chain comprising a shaft; a moveable member having a hole at one end thereof for receiving the shaft; a depending leg at an other end thereof for periodic contact with the chain so as to activate the discharge of lubricant on to the chain; the moveable part comprising a soft material.

It is another object of this invention to provide a method of minimizing damage to a conveyor system due to the displacement of a lubricating member by selecting the material of the activating member from a group of materials which is destructible by the conveyor system without affecting the conveyor system.

### BRIEF DESCRIPTION OF DRAWINGS

These and other features and objects of the invention shall now be described in relation to the following drawings.

FIG. 1 is a side perspective view of a lubricating applicator.

FIG. 2 is a front perspective view of the lubricating applicator.

FIG. 3 is a front elevational view of the lubricating applicator.

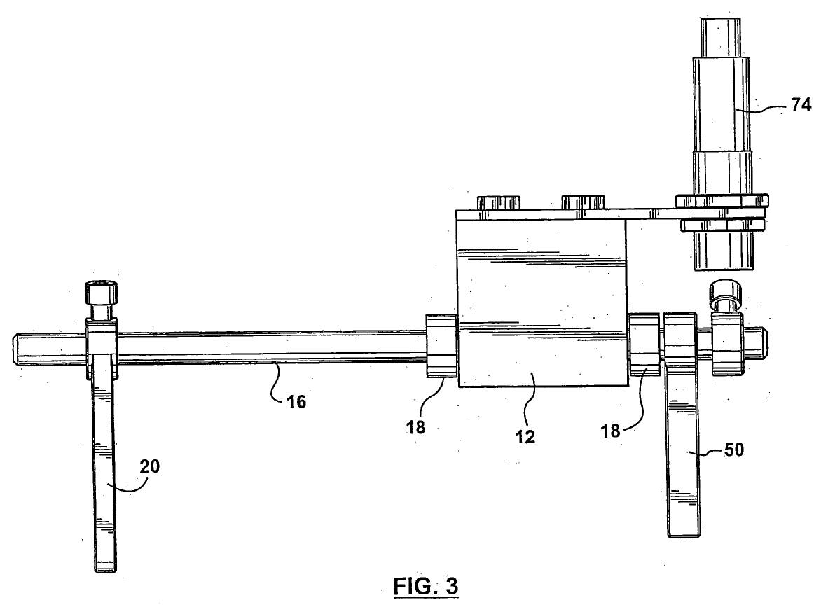

FIG. 4 is a side elevational view of the lubricating applicator from the left side of FIG. 3.

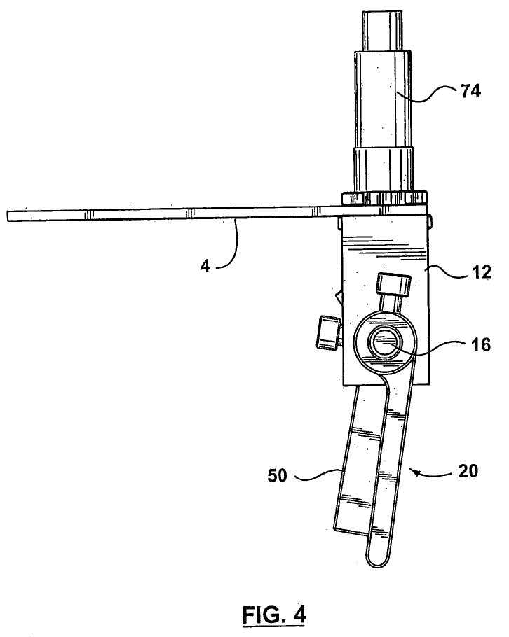

FIG. 5 is a right side elevational view of lubricating applicator from the right side of FIG. 3.

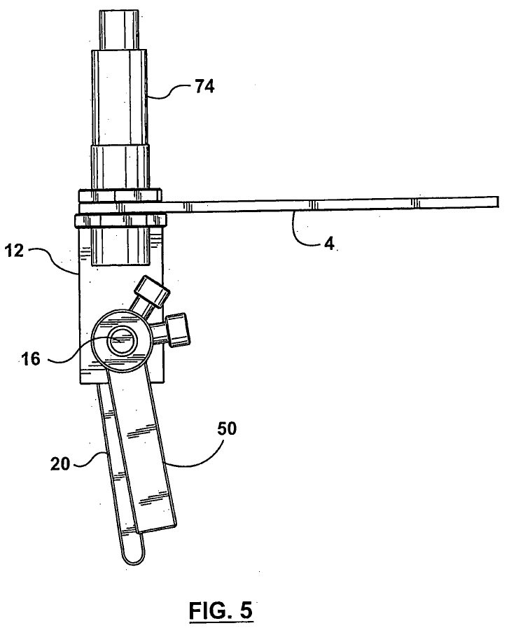

### DESCRIPTION OF THE INVENTION

In the description which follows, like parts are marked throughout the specification and the drawings with the same respective reference numerals. The drawings are not necessarily to scale and in some instances proportions may have been exaggerated in order to more clearly depict certain features of the invention.

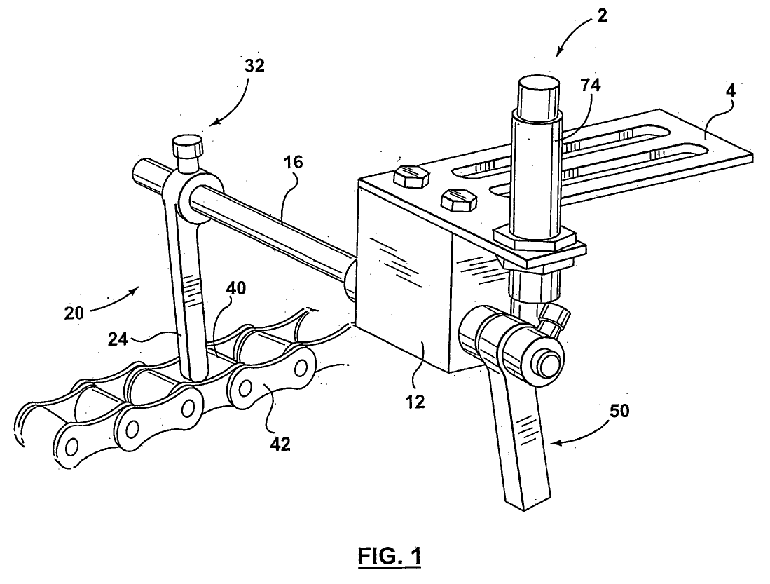

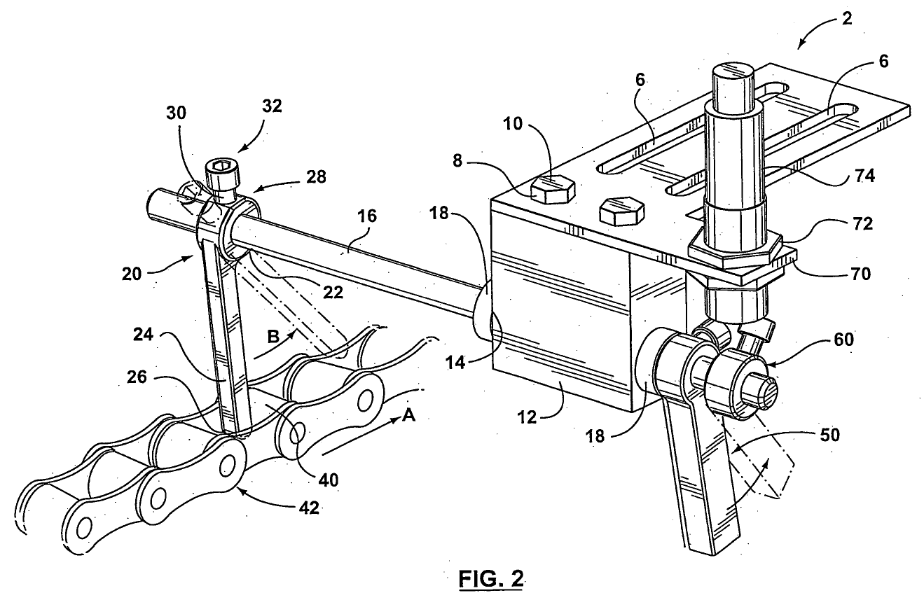

FIGS. 1 and 2 illustrate a device 2 consisting of a lubricating applicator. The device 2 includes a bracket 4 having a plurality of slots 6. FIG. 1 illustrates the use of two slots which are adapted to receive fastening means (not shown) such as bolts, screws or the like whereby the device 2 may be selectively fastened to any location requiring lubrication such as a conveyor system for purposes of lubricating same.

The bracket 4 also includes holes 8 which are adapted to receive other fastening means 10 such as bolts or the like as shown in FIG. 2.

Furthermore, a block 12 includes threaded holes to receive the fastening means 10 so as to secure the bracket 4 to the block 12. The block can comprise a block of metal such as steel, aluminium, plastic or the like.

The block 12 also includes a bore 14 which is adapted to receive shaft 16 there through as shown in FIG. 2.

In particular, the shaft 16 is adapted for rotational movement within the bore 14. The shaft 16 can also include locating sleeves 18 which can slide on to the shaft and be selectively fastened thereto (such as by means of allen screws (not shown)) which can be threaded through the sleeves 18 and secured to the shaft 16 so as to locate the shaft 16 relative to the block 12.

Generally speaking shaft 16 will comprise of a durable material such as steel or the like.

The lubricating device 2 also includes a moveable member 20 for activating the discharge lubricant. The moveable member 20 can comprise a hole 22 at one end 28 thereof for receiving a shaft 16 as shown in the figures.

The moveable member 20 also comprises at an other end or distal end 26 thereof a depending leg 24 whereby the distal end 26 is adapted to periodically contact a link 40 of a moving chain 42 as shown.

The one end 28 of the moveable member 20 also includes a radially disposed hole 30 adapted to receive a locking or fastening means 32 which can comprise of a variety of means including an allen screw as shown. Accordingly, by tightening the allen screw 30 the moveable member 30 may be selectively radially positioned relative to the shaft 16 so as to be optimally moved by the links 40 of the chain 42 as shown.

The shaft 16 can include at the other end thereof, another moveable member 50 which can operate in the same manner as that described above and can be activated by another chain or other moving member.

Moreover, retaining means 60 may be utilized so as to retain and prevent the moveable member 50 from accidentally falling off the end of the shaft.

The bracket 4 can also include a locating tab 70 having an aperture 72 which is adapted to receive a lubricating discharge cylinder 74 or the like.

As the chain 42 travels in the direction A the link 40 of a moving chain 42 periodically contact the distant end 26 of the leg 24 causing the moveable member 20 to rotate in a direction of arrow B thereby signalling the discharge of lubricant from the lubricant discharging means 74 in a manner well known to those persons skilled in the art.

However, over time the fastening means 32 can loosen thereby causing the moveable member 20 to slip off the end of the shaft into machinery, driving means, or chain and causing damage particularly when the moveable member is comprised of a hard material such as steel or the like.

In accordance with the invention described therein, the moveable member is comprised of a soft material which is breakable or easily ground if it falls into machinery driving means such as gears, or other chains or the like. In one embodiment the moveable member comprises of aluminium or plastic.

The invention described herein comprises of a method of minimizing damage to machinery such as a conveyor system due to the displacement of a lubricating activating member 20 by selecting the material of the activating member 20 from a group of materials which is destructible by the conveyor system without affecting the conveyor system. The material can be selected from a group of aluminium, plastic, rubber or other similar material which can be ground up, or destroyed without destroying the conveyor system.

Although the preferred embodiment as well as the operation and use have been specifically described in relation to the drawings, it should be understood that the variations in the preferred embodiment can be achieved by a person skilled in the trade without the parting from the spirit of the invention as claimed.

I claim:

1. A moveable member for activating the discharge of lubricant wherein the moveable member is comprised of a breakable material.

2. A moveable member as claimed in claim 1 wherein said breakable material comprises aluminium.

3. A moveable member as claimed in claim 2 herein said moveable member is removeably securable to a shaft.

4. A moveable member as claimed in claim 3 wherein said moveable member comprises a hole at one end for receiving the shaft and a depending leg at the other end thereof.

5. A moveable member as claimed in claim 4 wherein said moveable member is selectably rotatable about the shaft to a selected position.

6. A moveable member as claimed in claim 5 wherein said moveable member includes locking means for locking the moveable member in the selected position.

7. A moveable member as claimed in claim 6 wherein the leg is adapted to be moved by links on a chain.

8. A device for activating the discharge of a lubricant to a chain comprising:
(a) a shaft
(b) a moveable member having a hole at one end thereof for receiving the shaft
(c) a depending leg at another end thereof for periodic contact with the chain so as to activate the discharge of lubricant to the chain
(d) locking means carried by the moveable member to lock the moveable member to a selected position on the said shaft
(e) the moveable member comprising a soft material.

9. A device as claimed in claim 8 wherein said soft material comprises aluminium.

10. A device as claimed in claim 9 wherein said aluminium moveable member is destructible when accidentally dislodged from the shaft.

11. A method of minimizing damage to a conveyor system due to the displacement of a lubricating activating member by selecting the material of the activating member from a group of materials which is destructible by the conveyor system without affecting the conveyor system.

12. A method as claimed in claim 11 wherein said material comprises aluminium

13. A method as claimed in claim 11 wherein said material comprises plastic.
